(19) United States
(12) Patent Application Publication
(10) Pub. No.: US 2010/0011025 A1
(43) Pub. Date: Jan. 14, 2010

(54) TRANSFER LEARNING METHODS AND APPARATUSES FOR ESTABLISHING ADDITIVE MODELS FOR RELATED-TASK RANKING

(75) Inventors: Zhaohui Zheng, Sunnyvale, CA (US); Gordon Guo-Zheng Sun, Redwood City, CA (US); Hongyuan Zha, Atlanta, GA (US)

Correspondence Address: BERKELEY LAW & TECHNOLOGY GROUP LLP, 17933 NW EVERGREEN PARKWAY, SUITE 250, BEAVERTON, OR, 97006, US

(73) Assignee: Yahoo! Inc., Sunnyvale, CA (US)

(21) Appl. No.: 12/170,296

(22) Filed: Jul. 9, 2008

(51) Int. Cl. G06F 17/30

(52) U.S. Cl. 707/200; 707/E17.005

(57) ABSTRACT

Exemplary methods and apparatuses are provided which may be used to establish a ranking function or the like, which may be used by a search engine or other like tool to search a related-task search domain.

### BACKGROUND

1. Field

The subject matter disclosed herein relates to data processing, and more particularly to machine learning techniques and related methods and apparatuses for establishing additive models, ranking functions, and/or the like that may be used, for example, in information extraction and information retrieval systems.

2. Information

Data processing tools and techniques continue to improve. Information in the form of data is continually being generated or otherwise identified, collected, stored, shared, and analyzed. Databases and other like data repositories are common place, as are related communication networks and computing resources that provide access to such information.

The Internet is ubiquitous; the World Wide Web provided by the Internet continues to grow with new information seemingly being added every second. To provide access to such information, tools and services are often provided which allow for the copious amounts of information to be searched through in an efficient manner. For example, service providers may allow for users to search the World Wide Web or other like networks using search engines. Similar tools or services may allow for one or more databases or other like data repositories to be searched.

With so much information being available, there is a continuing need for methods and systems that allow for relevant information to be identified and presented in an efficient manner.

### BRIEF DESCRIPTION OF DRAWINGS

Non-limiting and non-exhaustive aspects are described with reference to the following figures, wherein like reference numerals refer to like parts throughout the various figures unless otherwise specified.

FIG. 1. is a block diagram illustrating an exemplary transfer learning apparatus that may be implemented to establish a ranking function or the like, which may be tuned and used to support related-task searching.

FIG. 2 is a flow diagram illustrating an exemplary transfer learning method that may be implemented to establish a ranking function or the like, and which may be tuned and used to support related-task searching.

FIG. 3 is a block diagram illustrating an exemplary computing system including an information integration system having a search engine that may be adapted with a ranking function or the like, which may be tuned and used to support related-task searching.

FIG. 4 is a block diagram illustrating an exemplary embodiment of a computing environment all or portions of which may, for example, be adapted to implement at least a portion of the apparatus of FIG. 1, the method of FIG. 2, and/or the system of FIG. 3.

### DETAILED DESCRIPTION

Some portions of the detailed description which follow are presented in terms of algorithms and/or symbolic representations of operations on data bits or binary digital signals stored within memory, such as memory within a computing system and/or other like computing device. These algorithmic descriptions and/or representations are the techniques used by those of ordinary skill in the data processing arts to convey the substance of their work to others skilled in the art. An algorithm is here, and generally, considered to be a self-consistent sequence of operations and/or similar processing leading to a desired result. The operations and/or processing involve physical manipulations of physical quantities. Typically, although not necessarily, these quantities may take the form of electrical and/or magnetic signals capable of being stored, transferred, combined, compared and/or otherwise manipulated. It has proven convenient at times, principally for reasons of common usage, to refer to these signals as bits, data, values, elements, symbols, characters, terms, numbers, numerals and/or the like. It should be understood, however, that all of these and similar terms are to be associated with the appropriate physical quantities and are merely convenient labels. Unless specifically stated otherwise, as apparent from the following discussion, it is appreciated that throughout this specification discussions utilizing terms such as “processing”, “computing”, “calculating”, “associating”, “identifying”, “determining”, “allocating” and/or the like refer to the actions and/or processes of a computing platform, such as a computer or a similar electronic computing device, that manipulates and/or transforms data represented as physical electronic and/or magnetic quantities within the computing platform's memories, registers, and/or other information storage, transmission, and/or display devices.

With this in mind, some exemplary methods and apparatuses are described herein that may be used to establish a ranking function or the like, which may be used by a search engine or other like tool to determine how to respond to a search query. More specifically, as illustrated in the example implementations described herein, machine learning techniques are provided which may be implemented to establish an additive model, ranking function, and/or the like that may be used, for example, in information extraction and information retrieval systems.

The techniques described herein may, for example, be implemented to provide a machine learned ranking (MLR) function and/or other like evaluation model that may be adapted to determine a model judgment value (e.g., ranking) associated with a web document, search result summary, and/or the like. Such a ranking function or evaluation model may be established through a transfer learning process based, at least in part, on training data (e.g., human judgment values, model judgment values, etc.) associated with a set of web documents, search results, search result summaries, and/or other like searchable information associated with a first search domain and a second search domain. In certain example implementations, a first search domain may be associated with at least a first task and the second search domain may be associated with at least a second task that may be related in some manner to the initial-task. In certain example implementations, such a first task (e.g., “initial-task”) may include any task or tasks including general or multiple purpose tasks and/or more specific tasks. Likewise, in certain example implementations, such a second task (e.g., “related-task”) may include any task or tasks including general or multiple purpose tasks and/or more specific tasks.

For example, certain methods and apparatuses are presented which may be implemented to establish a related-task ranking function based, at least in part, on transfer learning using a limited amount of related-task training data and a more extensive amount of initial-task training data. Here, for example, initial-task data may be used to establish a initial-task model and the initial-task model may then be used to score related-task data. The resulting ranking scores (responses) may be considered along with labeled ranking scores to determine residual data. The residual data may be used as target training data for use in training an additive model that may, for example, be used in a second ranking function for the related-task search domain. Such a related-task ranking function may, for example, be applied to rank topical classification information for both query and web documents information extraction and information retrieval systems.

Before describing such exemplary methods and apparatuses in greater detail, the sections below will first introduce certain aspects of an exemplary computing environment in which information searches may be performed. It should be understood, however, that techniques provided herein and claimed subject matter are not limited to these example implementations. For example, techniques provided herein may be adapted for use in a variety of information processing environments, such as, e.g., database applications, etc.

The Internet is a worldwide system of computer networks and is a public, self-sustaining facility that is accessible to tens of millions of people worldwide. Currently, the most widely used part of the Internet appears to be the World Wide Web, often abbreviated “WWW” or simply referred to as just “the web”. The web may be considered an Internet service organizing information through the use of hypermedia. Here, for example, the HyperText Markup Language (HTML) may be used to specify the contents and format of a hypermedia document (e.g., a web page).

Unless specifically stated, an electronic or web document may refer to either the source code for a particular web page or the web page itself. Each web page may contain embedded references to images, audio, video, other web documents, etc. One common type of reference used to identify and locate resources on the web is a Uniform Resource Locator (URL).

In the context of the web, a user may “browse” for information by following references that may be embedded in each of the documents, for example, using hyperlinks provided via the HyperText Transfer Protocol (HTTP) or other like protocol.

Through the use of the web, individuals may have access to millions of pages of information. However, because there is so little organization to the web, at times it may be extremely difficult for users to locate the particular pages that contain the information that may be of interest to them. To address this problem, a mechanism known as a “search engine” may be employed to index a large number of web pages and provide an interface that may be used to search the indexed information, for example, by entering certain words or phases to be queried.

A search engine may, for example, include or otherwise employ on a “crawler” (also referred to as “crawler”, “spider”, “robot”) that may “crawl” the Internet in some manner to locate web documents. Upon locating a web document, the crawler may store the document's URL, and possibly follow any hyperlinks associated with the web document to locate other web documents.

A search engine may, for example, include information extraction and/or indexing mechanisms adapted to extract and/or otherwise index certain information about the web documents that were located by the crawler. Such index information may, for example, be generated based on the contents of an HTML file associated with a web document. An indexing mechanism may store index information in a database.

A search engine may provide a search tool that allows users to search the database. The search tool may include a user interface to allow users to input or otherwise specify search terms (e.g., keywords or other like criteria) and receive and view search results. A search engine may present the search results in a particular order, for example, as may be indicated by a ranking scheme. For example, the search engine may present an ordered listing of search result summaries in a search results display. Each search result summary may, for example, include information about a website or web page such as a title, an abstract, a link, and possibly one or more other related objects such as an icon or image, audio or video information, computer instructions, or the like.

While some or all of the information in certain search result summaries may be pre-defined or pre-written, for example, by a person associated with the website, the search engine service, and/or a third person or party, there may still be a need to generate some or all of the information in at least a portion of the search result summaries. Thus, if a search result summary does need to be generated, a search engine may be adapted to create a search result summary, for example, by extracting certain information from a web page.

With so many websites and web pages being available, it may be beneficial to identify which search result summaries may be more relevant, which search result summary features may be more or less important, and/or which search result summaries may be more or less informative. Unfortunately, collecting labeled (e.g., human) judgments regarding such search results and search result summaries tend to be laborious, time-consuming, and/or expensive. Moreover, with the continued growth of the Internet and/or other like information networks around the world, there may be a continuing need to effectively search related-task search domains such as, for example, may be associated with a particular country, region, market, language, topic, product, service, and/or the like.

With so many potential related-task search domains, it may be inefficient to collect enough labeled training data to establish an effective model and/or ranking function for each related-task search domain. Unfortunately, ranking functions trained on labeled documents for a particular language or region, for example, may not perform adequately for a different language or region.

In accordance with certain aspects of the present description, certain techniques have been developed to allow for existing information from at least one initial-task search domain and/or other possibly related search domain to be transfer learned by one or more additive models for use in a related-task ranking function, for example.

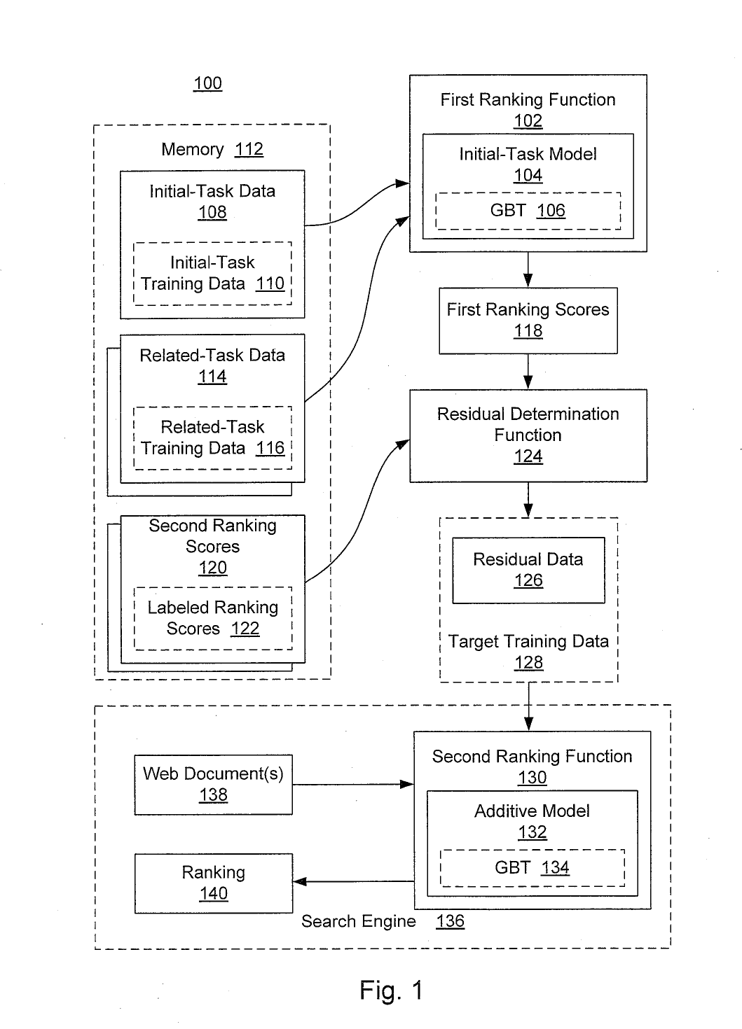

Reference is now made to FIG. 1, which is a block diagram illustrating an exemplary transfer learning apparatus 100 that may be implemented to establish a ranking function or the like, which may be tuned and used to support related-task searching.

Transfer learning apparatus 100 may, for example, include a first ranking function 102 associated with at least a first search domain. For example, first ranking function 102 may be associated with a initial-task search domain and may include or otherwise be operatively associated with a initial-task model 104. In certain example implementations, such a ranking function and/or model may include or otherwise be operatively associated with a gradient boosting tree (GBT) 106 and/or other like decision and/or hierarchical structure.

First ranking function 102 may, for example, be established based, at least in part, on initial-task data 108, shown here as being stored in memory 112. Initial-task data 108 may, for example, include initial-task training data 110. Such training data may include enough labeled training data or the like to sufficiently train/tune first ranking function 102. Such techniques are well known.

Related-task data 114 may be provided to established first ranking function 102 which may produce first ranking scores 118, for example. Here, related-task data may include related-task training data 116. Related-task data 114 may be associated with second ranking scores 120. Second ranking scores 120 may, for example, include labeled ranking scores 122 which correspond to task specific training data 116. Here, for example, labeled ranking scores 122 may include human judgments regarding the relevance of certain web documents for a given query as may be associated with a search engine or the like, and specified in related-task training data 116.

First ranking scores 118 and corresponding second ranking scores 120 may be provided to a residual determination function 124. While residual determination function 124 is illustrated as being separate from first ranking function 102 in this example, it should be understood that such functionality may be implemented within or without first ranking function or combined with other like functions and/or models in other implementations. In this example, residual determination function 124 may be adapted to determine residual data 126 based, at least in part, on first ranking scores 118 and second ranking scores 120.

Residual data 126 may be included in target training data 128. Target training data 128, although not illustrated in this example, may also include additional data such as, for example, all or part of any data in memory 112.

A second ranking function 130 may, for example, be established based, at least in part, on target training data 128. Such training data may include enough training data or the like to sufficiently train/tune an additive model 132 within and/or otherwise associated with second ranking function 130. In certain example implementations, additive model 132 may include or otherwise be operatively associated with a gradient boosting tree (GBT) 134 and/or other like decision and/or hierarchical structure.

Second ranking function 130 may, for example, be included within or otherwise be operatively associated with a search engine 136. In this manner, search engine 136 may be adapted for use in searching a related-task search domain, for example, as may be associated with related-task data 114. Here, for example, as illustrated in FIG. 1, second ranking function 130 may consider a web document 138 and determine a corresponding ranking 140.

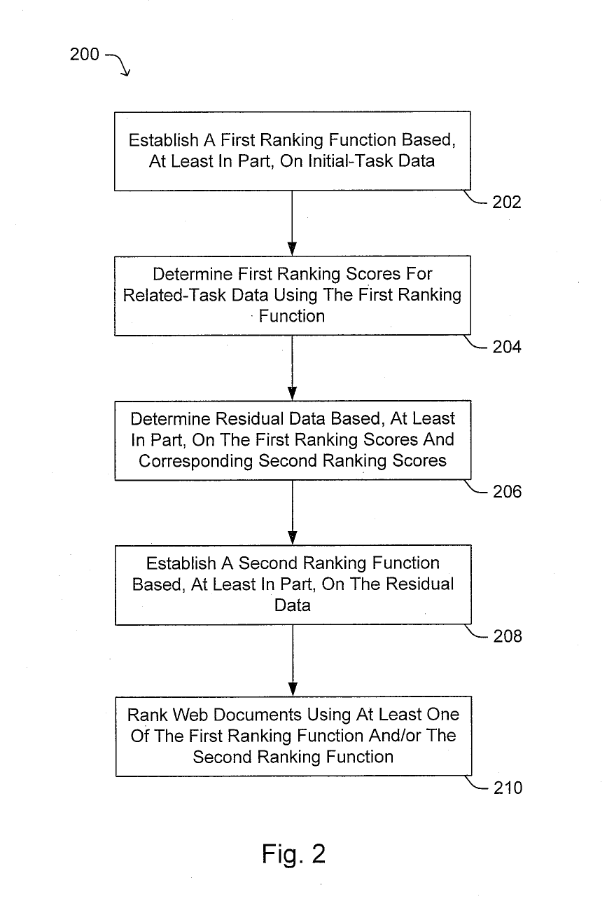

Attention is drawn next to FIG. 2, which is a flow diagram illustrating an exemplary transfer learning method 200 that may be implemented to establish a ranking function or the like, and which may be tuned and used to support related-task searching.

At block 202, a first ranking function may be established, for example, based, at least in part, on initial-task data. In certain example implementations a initial-task machine learned model may be trained, at least in part, using initial-task data, which may include initial-task training data. In certain implementations, such initial-task machine learned model may, for example, include or otherwise implement one or more gradient boosting trees.

At block 204, first ranking scores may be determined for related-task data using the first ranking function. Such related-task data may, for example, include related-task training data. Such related-task data may, for example, be associated with second ranking scores, which may include labeled ranking scores associated with the related-task training data.

At block 206, residual data may be determined based, at least in part, on the first ranking scores and corresponding second ranking scores. At least a portion of such residual data may, for example, be included in target training data.

At block 208, a second ranking function may be established based, at least in part, on the residual data. In certain example implementations an additive machine learned model may be trained, at least in part, using target training data which may include at least a portion of the residual data. In certain example implementations, such an additive machine learned model may, for example, include or otherwise implement one or more gradient boosting trees.

At block 210, at least one web document or the like may be ranked using at least one of the first ranking function and/or the second ranking function.

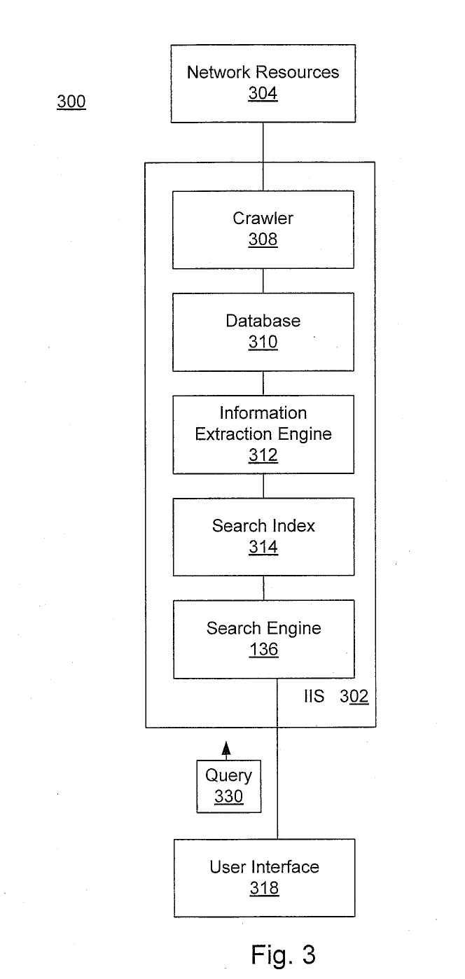

Attention is now drawn to FIG. 3, which is a block diagram illustrating an exemplary computing environment 300 having an Information Integration System (IIS) 302. Here, for example, IIS 302 may include a search engine 136 (e.g., as in FIG. 1) that may be adapted with a ranking function or the like which may be tuned and used to support related-task searching.

The context in which such an IIS may be implemented may vary. For non-limiting examples, an IIS such as IIS 302 may be implemented for public or private search engines, job portals, shopping search sites, travel search sites, RSS (Really Simple Syndication) based applications and sites, and the like. In certain implementations, IIS 302 may be implemented in the context of a World Wide Web (WWW) search system, for purposes of an example. In certain implementations, IIS 302 may be implemented in the context of private enterprise networks (e.g., intranets), as well as the public network of networks (i.e., the Internet).

IIS 302 may include a crawler 308 that may be operatively coupled to network resources 304, which may include, for example, the Internet and the World Wide Web (WWW), one or more servers, etc. IIS 302 may include a database 310, an information extraction engine 312, a search engine 136 backed, for example, by a search index 314 and possibly associated with a user interface 318 through which a query 330 may initiated.

Crawler 308 may be adapted to locate documents such as, for example, web pages. Crawler 308 may also follow one or more hyperlinks associated with the page to locate other web pages. Upon locating a web page, crawler 308 may, for example, store the web page's URL and/or other information in database 310. Crawler 308 may, for example, store an entire web page (e.g., HTML, XML, or other like code) and URL in database 310.

Search engine 136 may, for example, be used to index and/or otherwise search web pages associated with a related-task search domain as described herein. Search engine 136 may be used in conjunction with a user interface 318, for example, to retrieve and present related-task or other like information associated with search index 314. The information associated with search index 314 may, for example, be generated by information extraction engine 312 based on extracted content of an HTML file associated with a respective web page. Information extraction engine 312 may be adapted to extract or otherwise identify specific type(s) of information and/or content in web pages, such as, for example, job titles, job locations, experience required, etc. This extracted information may be used to index web page(s) in the search index 314. One or more search indexes 326 associated with search engine 136 may include a list of information accompanied with the network resource associated with information, such as, for example, a network address and/or a link to, the web page and/or device that contains the information. In certain implementations, at least a portion of search index 316 may be included in database 310.

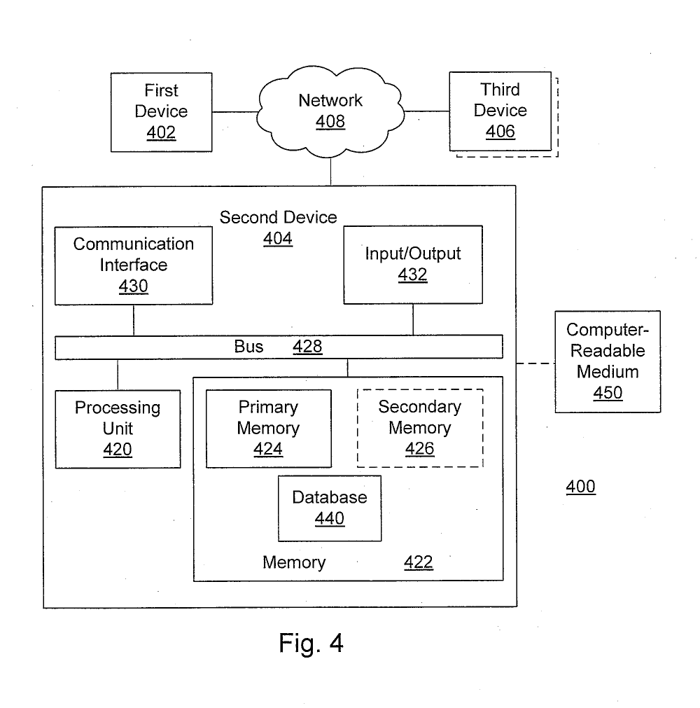

Reference is now made to FIG. 4, which is a block diagram illustrating an exemplary embodiment of a computing environment system 400 all or portions of which may, for example, be adapted to implement at least a portion of the apparatus of FIG. 1, the method of FIG. 2, and/or the system of FIG. 3.

Computing environment system 400 may include, for example, a first device 402, a second device 404 and a third device 406, which may be operatively coupled together through a network 408.

First device 402, second device 404 and third device 406, as shown in FIG. 4, are each representative of any device, appliance or machine that may be configurable to exchange data over network 408 and host or otherwise provide one or more replicated databases. By way of example but not limitation, any of first device 402, second device 404, or third device 406 may include: one or more computing devices or platforms, such as, e.g., a desktop computer, a laptop computer, a workstation, a server device, storage units, or the like.

Network 408, as shown in FIG. 4, is representative of one or more communication links, processes, and/or resources configurable to support the exchange of data between at least two of first device 402, second device 404 and third device 406. By way of example but not limitation, network 408 may include wireless and/or wired communication links, telephone or telecommunications systems, data buses or channels, optical fibers, terrestrial or satellite resources, local area networks, wide area networks, intranets, the Internet, routers or switches, and the like, or any combination thereof.

As illustrated, for example, by the dashed lined box illustrated as being partially obscured of third device 406, there may be additional like devices operatively coupled to network 408.

It is recognized that all or part of the various devices and networks shown in system 400, and the processes and methods as further described herein, may be implemented using or otherwise include hardware, firmware, software, or any combination thereof.

Thus, by way of example but not limitation, second device 404 may include at least one processing unit 420 that is operatively coupled to a memory 422 through a bus 428.

Processing unit 420 is representative of one or more circuits configurable to perform at least a portion of a data computing procedure or process. By way of example but not limitation, processing unit 420 may include one or more processors, controllers, microprocessors, microcontrollers, application specific integrated circuits, digital signal processors, programmable logic devices, field programmable gate arrays, and the like, or any combination thereof.

Memory 422 is representative of any data storage mechanism. Memory 422 may include, for example, a primary memory 424 and/or a secondary memory 426. Primary memory 424 may include, for example, a random access memory, read only memory, etc. While illustrated in this example as being separate from processing unit 420, it should be understood that all or part of primary memory 424 may be provided within or otherwise co-located/coupled with processing unit 420.

Secondary memory 426 may include, for example, the same or similar type of memory as primary memory and/or one or more data storage devices or systems, such as, for example, a disk drive, an optical disc drive, a tape drive, a solid state memory drive, etc. In certain implementations, secondary memory 426 may be operatively receptive of, or otherwise configurable to couple to, a computer-readable medium 450. Computer-readable medium 450 may include, for example, any medium that can carry and/or make accessible data, code and/or instructions for one or more of the devices in system 400.

Additionally, as illustrated in FIG. 4, memory 422 may include a data associated with a database 440. Such data may, for example, be stored in primary memory 424 and/or secondary memory 426. Memory 422 may include, for example, memory 112 of FIG. 1.

Second device 404 may include, for example, a communication interface 430 that provides for or otherwise supports the operative coupling of second device 404 to at least network 408. By way of example but not limitation, communication interface 430 may include a network interface device or card, a modem, a router, a switch, a transceiver, and the like.

Second device 404 may include, for example, an input/output 432. Input/output 432 is representative of one or more devices or features that may be configurable to accept or otherwise introduce human and/or machine inputs, and/or one or more devices or features that may be configurable to deliver or otherwise provide for human and/or machine outputs. By way of example but not limitation, input/output device 432 may include an operatively adapted display, speaker, keyboard, mouse, trackball, touch screen, data port, etc.

Certain exemplary techniques will now be described which may be implemented in or otherwise adapted for use in least a portion of the apparatus of FIG. 1, the method of FIG. 2, and/or the system of FIG. 3. Those skilled in the art will recognize, however, that the various techniques provided herein are applicable and/or otherwise adaptable, in whole or part, to other apparatuses, methods and/or systems.

To design a retrieval function such as a search engine, ranking function or other like data processing tool or mechanism, one may, for example, construct training set by sampling a set of queries {qᵢ}ᵢ₌₁^{Q} from the query logs of a search engine or the like, and for each query q, one may also sample a set of documents for labeling to obtain,

{d_{qj},l_{qj}}, q=1, . . . , Q, j=1, . . . , n_{q}

where l_{qj} may be labels obtained from human judges for example after relevance assessment. Such labels may, for example, include quantitative values for judgments of Excellent, Fair, or Poor, etc. For an arbitrary query-document pair {q,d_{qj}}, one may construct a retrieval function h(q,d_{qj}) that matches the labels in some manner. To this end one may seek to solve the following optimization,

$${min}_{h ∈ H} {\sum }_{q = 1}^{Q} {\sum }_{j = 1}^{J} L ( {l}_{qj} , h ( q , {d}_{qj} ) ) + λ Ω ( h ) ,$$

where L is the selected loss function, λ is the regularization parameter that balances the fit of the model in terms of the empirical risk and the complexity of the model.

Suppose one is interested in learning the retrieval function h_{R}_{₀}, for a particular language or region R₀ and in addition to training examples for R₀,

D₀={d_{qj}⁰,l_{qj}⁰}, q=1, . . . , Q⁰, j=1, . . . , n_{q},

one also has access to training examples for several other languages and regions, i.e., for i=1, . . . , k,

Dᵢ={d_{qj}ⁱ,l_{qj}ⁱ}, q=1, . . . , Qⁱ, j=1, . . . , n_{q}ⁱ,

One may just use D₀ to train h_{R}_{₀}, but doing so may ignore certain potentially useful information that may be present in the other Dᵢ's about h_{R}_{₀}. Indeed, in certain situations, it may be that the retrieval functions h_{R}_{ᵢ}'s for other languages and regions will not be the same as h_{R}_{₀} but may be similar to h_{R}_{₀} in some manner. Therefore, when training h_{R}_{₀} one may attempt to exploit at least a portion of the information in the Dᵢ's, which may, for example, be considered as prior information to enhance the training of h_{R}_{₀}.

Below is an example process that may be implemented to encode or otherwise make use of such prior information in ∪ᵢ₌₁^{k} Dᵢ and use such for the training of h_{R}_{₀}. This exemplary approach may encode such prior information in the form of a first ranking function trained on all ∪ᵢ₌₁^{k} Dᵢ and use that first ranking function as an informative initial function to further train h_{R}_{₀} using the data D₀ only.

By way of example but not limitation, this exemplary approach is presented within the general framework of gradient boosting which is described in the following process, wherein it is assumed that one has access to a training set {xᵢ,yᵢ}ᵢ₌₁^{N} with a loss function L(y,ƒ(x)).

1. Initialize ƒ₀ (x)=arg min_{γ}Σᵢ₌₁^{N}L(yᵢ,γ).

2. For j=1, . . . , M: (number of gradient boosting)

(a) For i=1, . . . , N, compute the negative gradient

$${r}_{im} = - {[ \frac{\partial L ( y , f ( {x}_{i} ) )}{\partial f ( {x}_{i} )} ]}_{f ( {x}_{i} ) = {f}_{m - 1 ( {x}_{i} )}}$$

(b) Fit a regression tree to {rᵢₘ}ᵢ==1, . . . , N giving terminal regions Rⱼₘ, j=1, . . . , Jₘ.

(c) For j=1, . . . , Jₘ, compute

$${γ}_{jm} = arg {min}_{γ} {\sum }_{{x}_{i} ∈ {R}_{jm}} L ( {y}_{i} , {f}_{m - 1} ( {x}_{i} ) + γ )$$

(d) Update

$${f}_{m} ( x ) = {f}_{m - 1} ( x ) + η ( {\sum }_{j = 1}^{{J}_{m}} {γ}_{jm} I ( x ∈ {R}_{jm} ) )$$

where η is the shrinkage factor.

In an exemplary approach one may, for example, incorporate the information in the training data Dᵢ, i≠0, from other languages to train a ranking function h_{R}_{₀}(q,d) for a particular function R₀ is to train a ranking function ƒ₀(q,d) using all the training data D≡∪ᵢ₌₁^{k}Dᵢ∪D₀ i.e.,

$${f}_{0} arg {min}_{h ∈ H} {\sum }_{i = 0}^{k} {\sum }_{q = 1}^{Q} {\sum }_{j = 1}^{J} L ( {l}_{qj}^{i} , h ( q , {d}_{qj}^{i} ) ) + λ Ω ( h )$$

One may then use the above ƒ₀ (q,d) as the initial function in gradient boosting to address the following minimization,

$${min}_{h ∈ H} {\sum }_{q = 1}^{Q} {\sum }_{j = 1}^{{n}_{q}} L ( {l}_{qj}^{0} , h ( q , {d}_{qj}^{0} ) ) + λ Ω ( h ) .$$

Notice here the training data may be those in D₀ which may correspond to the language R₀ (e.g., a related-task search domain). One may, for example, also consider the above as fitting the residual l−ƒ₀(q,d) using D₀. One rationale behind such an exemplary approach may be that information contained in ∪ᵢ₌₁^{k}Dᵢ for training h_{R}_{₀}(q,d) may be extracted in the form of a second ranking function ƒ₀(q,d), the training data in D₀ may then used to augment ƒ₀(q,d) to capture information for h_{R}_{₀}(q,d) that may be specific for R₀.

While certain exemplary techniques have been described and shown herein using various methods and systems, it should be understood by those skilled in the art that various other modifications may be made, and equivalents may be substituted, without departing from claimed subject matter.

Additionally, many modifications may be made to adapt a particular situation to the teachings of claimed subject matter without departing from the central concept described herein. Therefore, it is intended that claimed subject matter not be limited to the particular examples disclosed, but that such claimed subject matter may also include all implementations falling within the scope of the appended claims, and equivalents thereof.

What is claimed is:

1. A method comprising, with at least one computing device:
determining first ranking scores for related-task data using a first ranking function;
determining residual data based, at least in part, on said first ranking scores and corresponding second ranking scores; and
establishing a second ranking function based, at least in part, on said residual data.

2. The method as recited in claim 1, with said at least one computing device further comprising establishing said first ranking function based, at least in part, on initial-task data.

3. The method as recited in claim 2, wherein establishing said first ranking function comprises establishing a initial-task machine learned model trained, at least in part, using said initial-task data.

4. The method as recited in claim 3, wherein said initial-task data comprises initial-task training data.

5. The method as recited in claim 3, wherein said initial-task machine learned model comprises a gradient boosting tree.

6. The method as recited in claim 1, wherein establishing said second ranking function comprises establishing an additive machine learned model trained, at least in part, using target training data, said target training data comprising said residual data.

7. The method as recited in claim 6, wherein said an additive machine learned model comprises a gradient boosting tree.

8. The method as recited in claim 1, wherein said related-task data comprises related-task training data.

9. The method as recited in claim 8, wherein said second ranking scores comprise labeled ranking scores associated with said related-task training data.

10. The method as recited in claim 1, comprising, within a computing environment, using at least one of said first ranking function and/or said second ranking function to rank web documents.

11. An apparatus comprising:
memory adapted to store at least related-task data and second ranking scores; and
at least one processing unit coupled to said memory and adapted to determine first ranking scores based, at least in part, on said related-task data using a first ranking function, determine residual data based, at least in part, on said first ranking scores and corresponding said second ranking scores, and establish a second ranking function based, at least in part, on said residual data.

12. The apparatus as recited in claim 11, wherein said memory is further adapted to store initial-task data, and said at least one processing unit is further adapted to establish said first ranking function based, at least in part, on said initial-task data.

13. The apparatus as recited in claim 12, wherein said at least one processing unit is further adapted to establish a initial-task machine learned model trained, at least in part, using said initial-task data.

14. The apparatus as recited in claim 11, wherein said memory is further adapted to store target training data, said target training data comprising said residual data, and said at least one processing unit is further adapted to establish an additive machine learned model trained, at least in part, using said target training data.

15. The apparatus as recited in claim 14, wherein said an additive machine learned model comprises a gradient boosting tree.

16. The apparatus as recited in claim 11, wherein said related-task data comprises related-task training data, and said second ranking scores comprise labeled ranking scores associated with said related-task training data.

17. A computer readable medium comprising computer implementable instructions stored thereon, which if implemented adapt one or more processing units to:
determine first ranking scores for related-task data using a first ranking function;
determine residual data based, at least in part, on said first ranking scores and corresponding second ranking scores; and
establish a second ranking function based, at least in part, on said residual data.

18. The computer readable medium as recited in claim 17, comprising further computer implementable instructions stored thereon, which if implemented adapt one or more processing units to establish an additive machine learned model trained, at least in part, using target training data, said target training data comprising said residual data.

19. The computer readable medium as recited in claim 18, wherein said an additive machine learned model comprises a gradient boosting tree.

20. The computer readable medium as recited in claim 17, wherein said second ranking scores comprise labeled ranking scores associated with said related-task training data.
